(19) United States
(12) Patent Application Publication
(10) Pub. No.: US 2014/0323231 A1
(43) Pub. Date: Oct. 30, 2014

(54) FLEXIBLE SHAFT ASSEMBLY

(71) Applicant: Kenneth Perry, Youngsville, LA (US)

(72) Inventor: Kenneth Perry, Youngsville, LA (US)

(21) Appl. No.: 14/262,182

(22) Filed: Apr. 25, 2014

Related U.S. Application Data
(60) Provisional application No. 61/816,262, filed on Apr. 26, 2013.

(51) Int. Cl. F16C 1/08

(52) U.S. Cl. CPC F16C 1/08
USPC 464/54; 464/81

(57) ABSTRACT

A flexible shaft assembly has first and second end connection members and a body section between the end members. The body section comprises a core member with elongate load supporting elements disposed around the outer surface of the core. An optional outer material can also encase the load supporting elements and core. The shaft assembly is sufficiently rigid to transfer torque and other forces, yet sufficiently flexible to permit angular displacement along its longitudinal axis.

### CROSS REFERENCES TO RELATED APPLICATION

PRIORITY OF U.S. PROVISIONAL PATENT APPLICATION Ser. No. 61/816,262, FILED Apr. 26, 2013, INCORPORATED HEREIN BY REFERENCE, IS HEREBY CLAIMED.

### STATEMENTS AS TO THE RIGHTS TO THE INVENTION MADE UNDER FEDERALLY SPONSORED RESEARCH AND DEVELOPMENT

NONE

### BACKGROUND OF THE INVENTION

1. Field of the Invention

The present invention relates to a flexible shaft assembly. More particularly, the present invention pertains to a versatile shaft assembly capable of transferring torque and other forces between objects. More particularly still, the present invention pertains to a versatile shaft assembly that can transfer torque and other forces between objects, including axially misaligned components, without the use of swivel assemblies (such as, for example, knuckle or universal joints) having discontinuities.

2. Brief Description of the Prior Art

In many systems, a power generating device is used to drive another work-producing device. In such systems, a so-called drive shaft is frequently used to transfer torque from said power generating device to said other device, especially when said components cannot be directly connected to each other (typically because of spatial relationship of the components, or the need to allow for relative movement between said components). In such instances, said drive shaft typically comprises a mechanical “bridge” or linkage member for transmitting torque and other forces from one component to another. By way of illustration, but not limitation, a drive shaft is often used to connect an output shaft of an automobile engine (power generating device) to an input shaft of an axle (work producing device).

Because drive shafts are frequently used to transmit torque, such drive shafts are generally subject to torsion forces and shear stresses. As a result, drive shafts generally must be sufficiently strong to bear such forces and stresses, while simultaneously avoiding excess weight that could increase undesirable inertia. Further, in many instances, one end of a drive shaft (which may be connected to an output shaft of a power generating device, for example) may not be axially aligned with the opposite end of said drive shaft (which may be connected to the input shaft of another device, for example).

In order to accommodate such axial misalignment, conventional drive shafts frequently include at least one swivel assembly such as, for example, a knuckle joint, universal joint or other similar device. In many cases, two such swivel assemblies are used; a first swivel assembly is disposed at or near a first end of said drive shaft, while a second swivel assembly is disposed at or near the opposite end of said drive shaft. Without such swivel assemblies, a completely rigid shaft can break, particularly when misaligned and exposed to significant torque forces. However, because such swivel assemblies generally contain discontinuities, said swivel assemblies can often comprise the weakest and most limiting components within an overall system.

Thus, there is a need for a flexible shaft that does not include a swivel assembly. Said drive shaft should be sufficiently flexible to allow for angular changes and axial misalignment, while also being sufficiently rigid to permit the transfer of torque and other forces between components. In addition to serving as a conventional mechanical drive shaft, the flexible shaft should also accommodate other beneficial uses. For example, the flexible shaft should be capable of damping a powered system, and/or absorbing shock loads, spikes or vibration in a passive system (e.g., between the ground and a structure during seismic activity).

### SUMMARY OF THE INVENTION

The present invention comprises a flexible shaft assembly that permits the transmission of torque between two components (such as, for example, between a power generating member and a work-performing member), including components that are not in axial alignment with each other. In addition to functioning as a drive shaft or linkage member, the flexible shaft of the present invention can also perform other beneficial uses. By way of illustration, but not limitation, the flexible shaft assembly of the present invention can be used for damping in a powered system, as well as absorbing shock loads or spikes.

In a preferred embodiment, the flexible shaft assembly of the present invention comprises first and second end members and a body section disposed there between. Said first and second end members are adapted to attach said flexible shaft assembly to other components. As such, said first and second end members can include threaded connection members (such as sol or other attachment means.

Said body section comprises a core with elongate load supporting elements disposed around said core. Said core and elongate load supporting elements span the length of said shaft assembly between said end members. Although said core can transfer some torque forces, said core is sufficiently flexible to permit angular displacement along its longitudinal axis.

Said load supporting members support the majority of any torsional loading but also assist in damping angular motion. Said load supporting members can take various forms and can be constructed from various materials including, but not limited to, cables, wires, elastomer, urethane and/or the like. In an alternative embodiment, said load carrying elements can be beneficially encased in a flexible media.

Stress and loading forces can flow undisrupted along the length of said flexible shaft assembly because said shaft assembly is substantially continuous from end to end. Unlike conventional alternatives, the flexible shaft assembly of the present invention does not include swivel joint(s) or other discontinuities that can cause weakness and/or wear zones in said shaft. Because said flexible shaft assembly can rigidly link components, while allowing for angular displacement without swivels, knuckle joints or other discontinuities, the torque transmitting ability and durability of said shaft assembly increases.

Strengths, materials, configurations and/or dimensions of the shaft assembly of the present invention can be altered or adjusted to address various issues such as environmental concerns, corrosion, erosion, loading, speed and/or other requirements for different applications. Moreover, although the flexible shaft assembly of the present invention can be used in an actively powered system, said flexible shaft assembly can also be used in a torsionally oscillating system that is passively driven. For example, the flexible shaft assembly of the present invention can serve as a linkage between a stationary and moving system to dampen motion and vibration. The flexible shaft assembly of the present invention limits angular/axial displacement and absorbs torsional forces.

In an alternative embodiment, the flexible shaft assembly of the present invention includes a substantially continuous through bore which allows pumping of fluids and passage of cables, wires or other objects through said flexible shaft assembly.

### BRIEF DESCRIPTION OF DRAWINGS

The foregoing summary, as well as the following detailed description of the preferred embodiments, is better understood when read in conjunction with the appended drawings. For the purpose of illustrating the invention, the drawings show certain preferred embodiments. It is understood, however, that the invention is not limited to the specific methods and devices disclosed. Further, dimensions, materials and part names are provided for illustration purposes only and not limitation.

FIG. 1 depicts a side view of a flex shaft assembly of the present invention.

FIG. 2 depicts an end perspective sectional view of a flex shaft assembly of the present invention.

FIG. 3 depicts a perspective view of a flex shaft assembly of the present invention with certain material removed.

FIG. 4 depicts a perspective view of a first alternative embodiment flex shaft assembly of the present invention.

FIG. 5 depicts an end perspective sectional view of said first alternative embodiment flex shaft assembly of the present invention.

FIG. 6 depicts an end view of said first alternative embodiment flex shaft assembly of the present invention.

FIG. 7 depicts a side view of a second alternative embodiment flex shaft assembly of the present invention.

FIG. 8 depicts an end perspective view of said second alternative embodiment flex shaft assembly of the present invention.

FIG. 9 depicts a side view of a third alternative embodiment flex shaft assembly of the present invention.

FIG. 10 depicts an end perspective view of said third alternative embodiment flex shaft assembly of the present invention.

FIG. 11 depicts a side partial sectional view of a flex shaft assembly of the present invention installed as part of a downhole well drilling assembly.

FIG. 12 depicts a side perspective view of a conventional engine block mounted on a plurality of flex shaft assemblies of the present invention.

### DETAILED DESCRIPTION OF A PREFERRED EMBODIMENT

The present invention comprises a flexible shaft assembly that permits the transmission of torque and other forces between two components (such as, for example, between a power generating member and a work-performing member), including components that are not in axial alignment with each other. Importantly, while allowing for the efficient transfer of torque forces through said shaft assembly, the shaft assembly of the present invention permits deflection along its longitudinal axis without the use of swivel assemblies or other universal joints that include breaks or discontinuities. In addition to functioning as a drive shaft, the flexible shaft of the present invention can also perform other beneficial uses (e.g. providing damping effects in a powered system, absorbing shock loads, etc.).

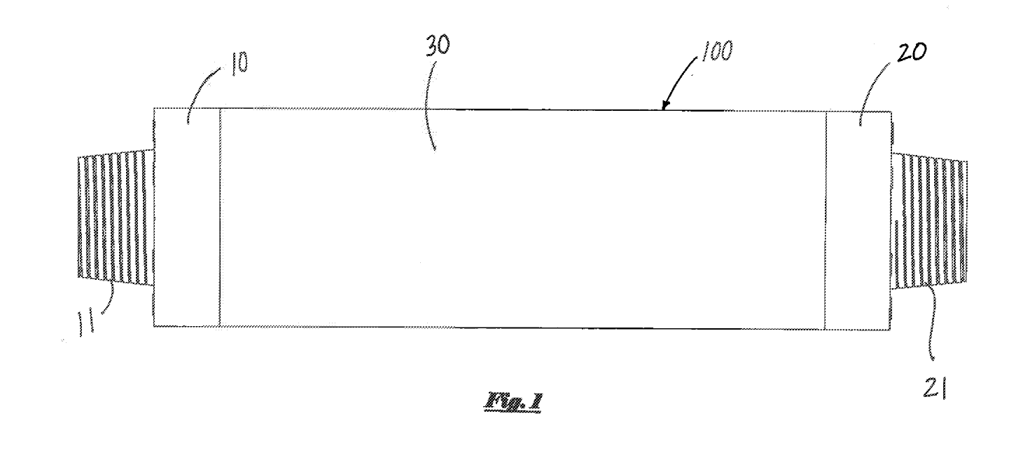

FIG. 1 depicts a side view of a flex shaft assembly 100 of the present invention. In a preferred embodiment, flexible shaft assembly 100 of the present invention comprises first end member 10 and second end member 20, as well as body section 30 disposed between said first and second end members. First end member 10 and second end member 20 are each adapted to attach said flexible shaft assembly 100 to other components. As such, first end member 10 is equipped with threaded connection member 11, while second end member 20 is similarly equipped with threaded connection member 21. Alternatively, it is to be observed that attachment means other than threaded connections—that is, attachment means that would permit said flex shaft assembly 100 to be securely connected to an adjacent component—can be used without departing from the scope of the present invention.

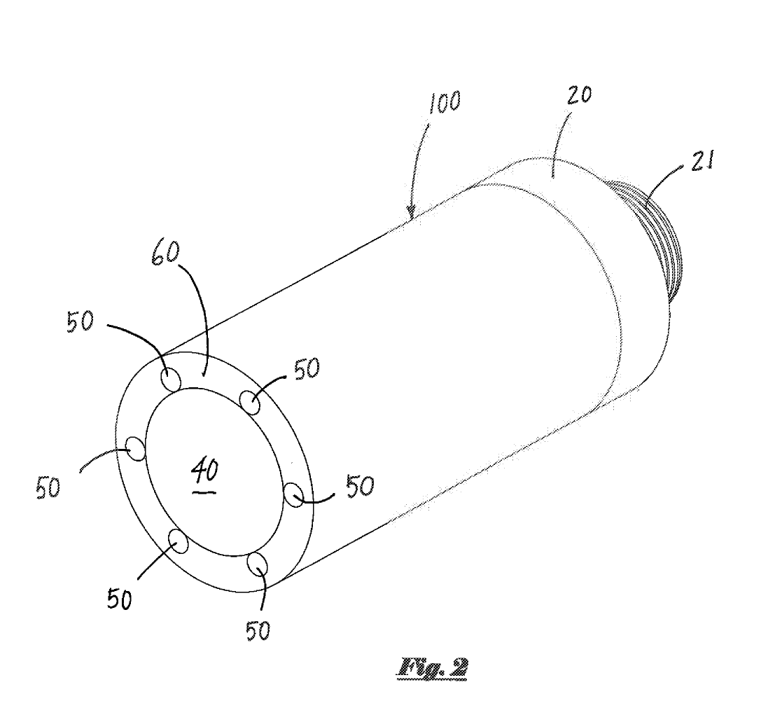

FIG. 2 depicts an end perspective sectional view of a flex shaft assembly 100 of the present invention. In the embodiment depicted in FIG. 2, flex shaft assembly 100 comprises substantially solid and cylindrical urethane inner core member 40. However, it is to be observed that inner core member 40 can be constructed of other natural and synthetic materials (such as, for example, metal, plastic or polymer), and can have other configurations (such as, for example, a coiled spring). A plurality of load supporting members 50 is disposed in spaced relationship around the outer surface of said core member 40. Said inner core member 40 and load supporting members 50 are beneficially disposed within casing material 60.

In a preferred embodiment, said casing material 60 comprises a synthetic polymer material that can encase core member 40 and load supporting members 50. Said casing material 60 can protect said load supporting members 50 and core member 40 from moisture and/or other environmental effects that could corrode, erode or otherwise damage or degrade said load supporting members 50 and core member 40. Additionally, said casing material 60 can include additives to adjust or alter physical properties of said casing material 60 (such as, for example, friction increasing material or the like) in order to improve performance under anticipated operational conditions.

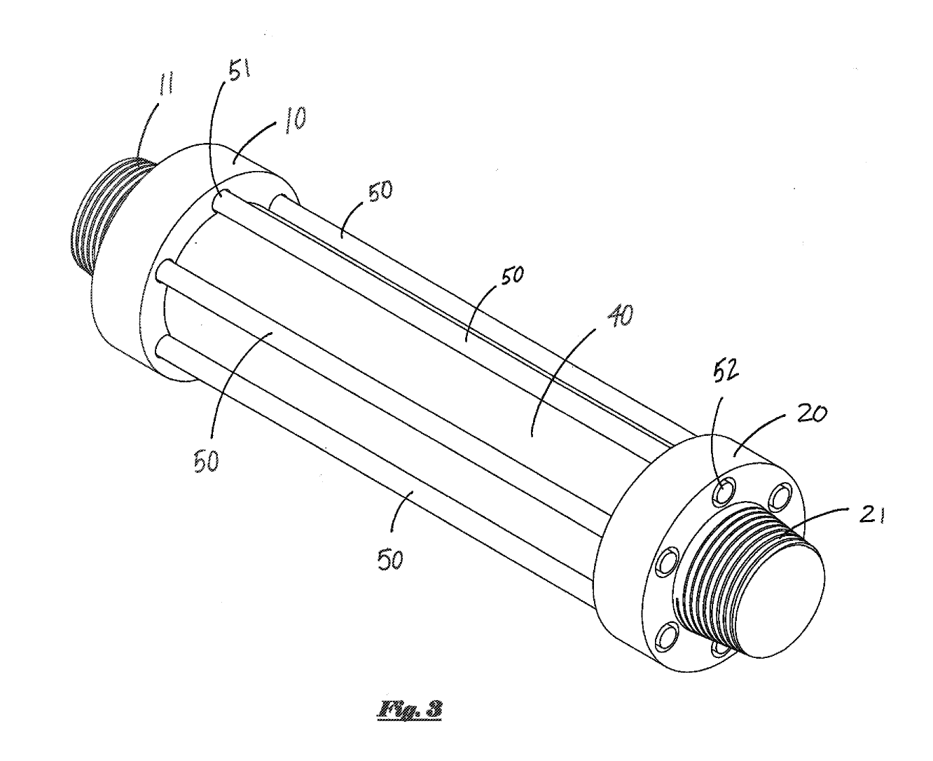

FIG. 3 depicts a perspective view of flex shaft assembly 100 of the present invention with casing material 60 removed for illustration purposes. Flexible shaft assembly 100 of the present invention comprises first end member 10 and second end member 20. First end member 10 is equipped with threaded connection member 11, while second end member 20 is equipped with threaded connection member 21.

Inner core member 40 extends between said first end member 10 and second end member 20. As depicted in FIG. 3, said inner core member 40 is a substantially solid cylindrical member constructed of urethane or other material exhibiting desired characteristics. A plurality of load supporting members 50 is disposed in spaced relationship around the outer surface of said core member 40.

As depicted in FIG. 3, each load supporting member 50 has a first end 51 and a second end 52; first end 51 is anchored to first end member 10, while second end 52 is anchored to second end member 20. Alternatively, it is to be observed that said load supporting members 50 can comprise one or more cables having lengths longer than the distance between said end members 10 and 20 that are threaded through apertures in one or both of said end members, strung between said end members, and secured or anchored in place.

As depicted in FIG. 3, inner core member 40 and elongate load supporting members 50 span the length of shaft assembly 100 between end members 10 and 20. In a preferred embodiment, said elongate load supporting members 50 comprise flexible cables or other similar structures manufactured from metal, solid core wire(s), carbon fibers, plastic, elastomer, urethane or other synthetic material. Further, in a preferred embodiment, said load supporting members 50 are placed in predetermined tensile loading between end members 10 and 20 in accordance with anticipated operational parameters.

Referring back to FIG. 2, although core member 40 and casing material 60 can transfer some torque forces, said core member 40 and casing material 60 are substantially axially rigid, yet sufficiently flexible to permit angular displacement or deflection of shaft assembly 100 along the longitudinal axis of said shaft assembly 100. Inner core member 40 and outer casing material 60 damp vibration, at least partially resist bending, at least partially support torsional loading, and absorb torsional and other shock loads.

Load supporting members 50 support the majority of any torsional loading acting on flex shaft assembly 100, but also assist in damping angular motion. As noted above, in a preferred embodiment said load supporting members 50 are subjected to predetermined tensile forces. When flex shaft assembly 100 is exposed to torque forces or twisting about its longitudinal axis, said load supporting members 50 will constrict or move radially inward toward said central longitudinal axis. When this occurs, said load supporting members 50 engage against the outer surface of inner core member 40, while also pulling end members 10 and 20 toward each other. Thus, in a preferred embodiment, inner core member 40 should have sufficient axial and radial strength to resist such loading.

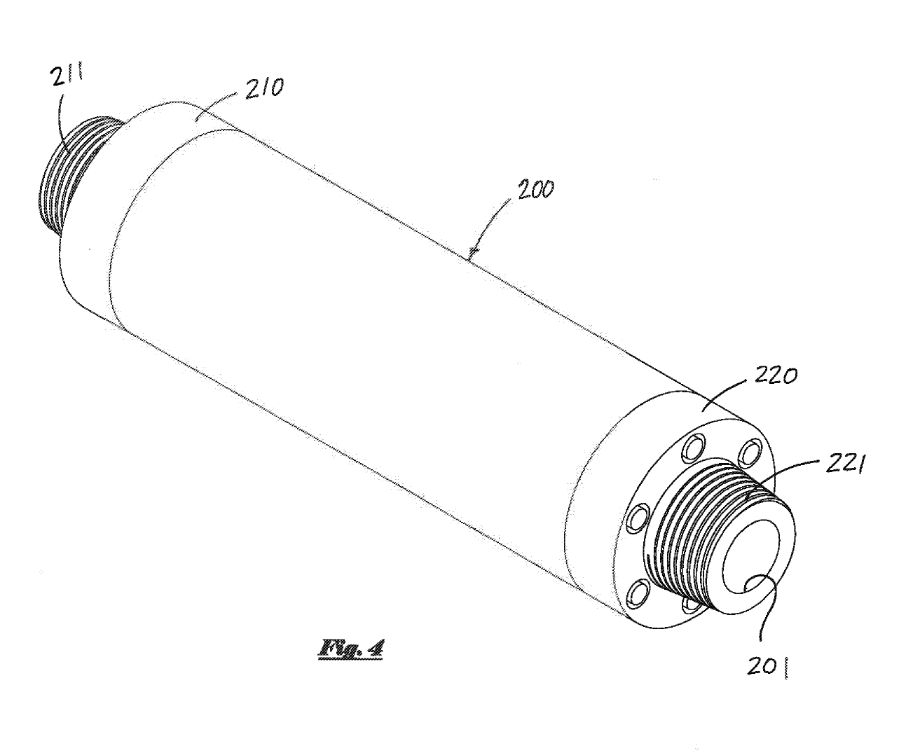

FIG. 4 depicts a perspective view of a first alternative embodiment flex shaft assembly 200 of the present invention. In the alternative embodiment depicted in FIG. 4, flexible shaft assembly 200 of the present invention is substantially similar to flex shaft assembly 100 in structure and function, except that alternative embodiment flex shaft 200 includes a substantially continuous central through bore 201 that extends from first end member 210 to second end member 220. Said through bore 201 extends through said alternative shaft assembly 200 substantially along its longitudinal axis. Said through bore 201 permits pumping of fluids and passage of cables, wires or other objects through said flexible shaft assembly 200.

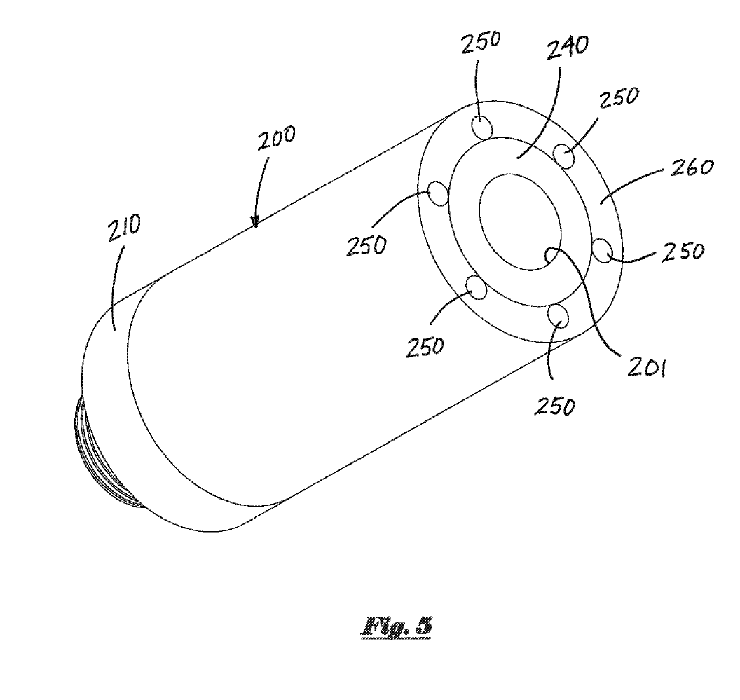

FIG. 5 depicts an end perspective sectional view of said first alternative embodiment flex shaft assembly 200 of the present invention. Inner core member 240 extends between said first end member 210 (and a second end member 220, not depicted in FIG. 5). A plurality of load supporting members 250 is disposed in spaced relationship around the outer surface of said core member 240.

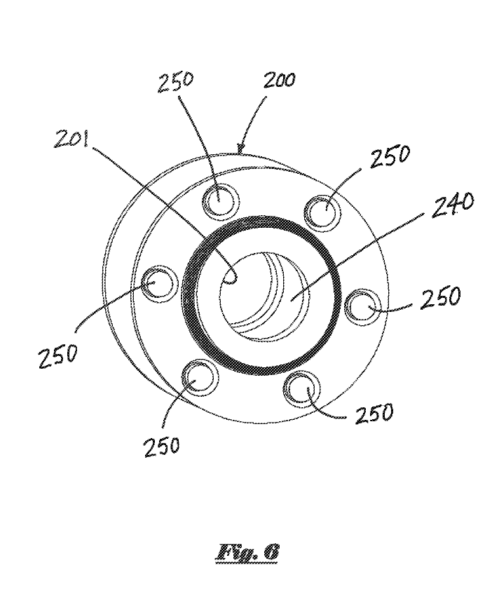

FIG. 6 depicts an end view of said first alternative embodiment flex shaft assembly 200 of the present invention. Inner core member 240 and elongate load supporting members 250 span the length of first alternative shaft assembly 200 between end members 210 and 220. Through bore 201 permits pumping of fluids and passage of cables, wires or other objects through said flexible shaft assembly 200. Further, said through bore 201 also reduces the weight of alternative embodiment flex shaft assembly 200, and varies certain performance characteristics compared to flex shaft assembly 100.

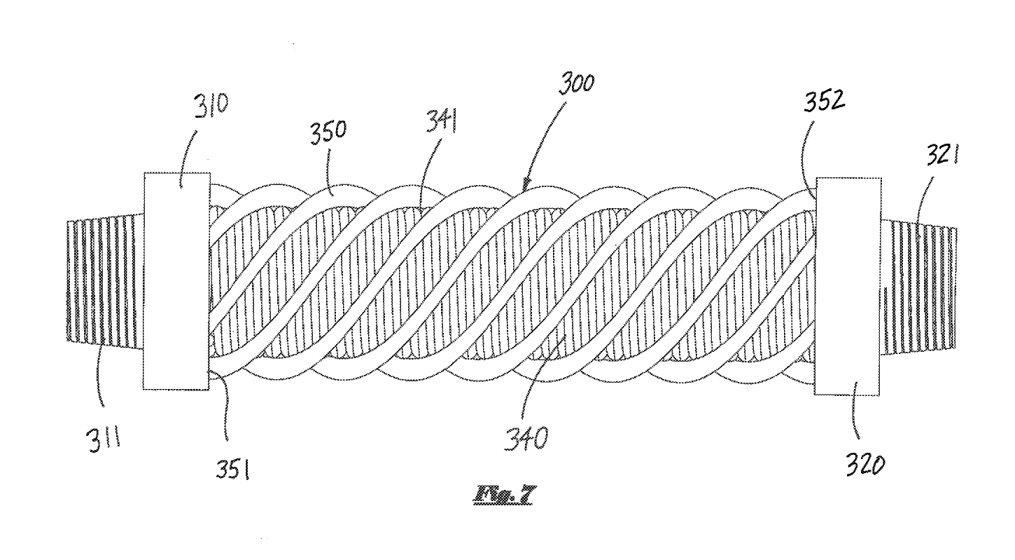

FIG. 7 depicts a side view of a second alternative embodiment flex shaft assembly 300 of the present invention. Alternative flexible shaft assembly 300 of the present invention comprises first end member 310 and second end member 320. First end member 310 is equipped with threaded connection member 311, while second end member 320 is equipped with threaded connection member 321.

Inner core member 340 extends between said first end member 310 and second end member 320. As depicted in FIG. 7, said inner core member 340 is a substantially solid member constructed of urethane or other material exhibiting desired characteristics. However, it is to be observed that inner core member 340 can be constructed of other natural and synthetic materials (such as, for example, metal, plastic or polymer), and can have other configurations (such as, for example, a coiled spring). Further, although inner core member 340 is substantially cylindrical in shape as depicted in FIG. 7, said core member 340 can include a plurality of grooves or recesses 341 that extend circumferentially around the outer surface of said inner core member 340 in substantially parallel orientation.

A plurality of substantially load supporting members 350 is disposed in a helical pattern in spaced relationship around the outer surface of said core member 340. Each load supporting member 350 has a first end 351 and a second end 352. As depicted in FIG. 7, first end 351 is anchored to first end member 310, while second end 352 is anchored to second end member 320. Alternatively, it is to be observed that said load supporting members 350 can comprise one or more cables having lengths longer than the distance between said end members 310 and 320 that are threaded through apertures in one or both of said end members, strung between said end members, and secured or anchored in place.

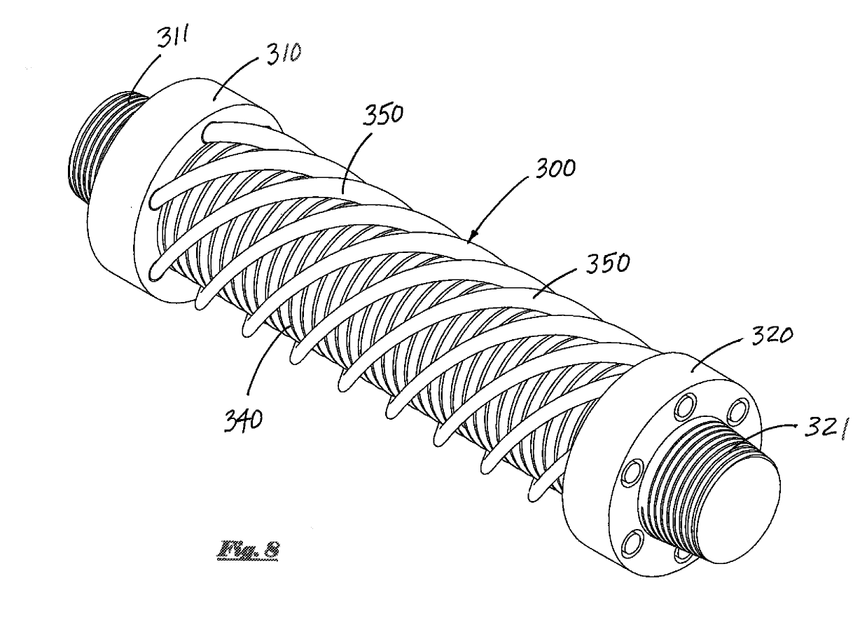

FIG. 8 depicts an end perspective view of said second alternative embodiment flex shaft assembly 300 of the present invention. Inner core member 340 and elongate load supporting members 350 span the length of shaft assembly 300 between end members 310 and 320. Although not depicted in FIG. 7 or FIG. 8, it is to be observed that an optional casing material (similar to casing material 60 depicted in FIG. 2) can also be optionally disposed over said core member 340 and helical load supporting members 350 between said end members 310 and 320, if desired.

Said core member 340 (as well as any optional casing material, if present) are axially rigid, yet sufficiently flexible, to permit angular displacement or deflection of shaft assembly 300 along the longitudinal axis of said shaft assembly 300. Inner core member 340 and any outer casing material serve to damp vibration, at least partially resist bending, at least partially support torsional loading and absorb torsional and other shock loads.

In a preferred embodiment, said elongate load supporting members 350 comprise flexible cables or other similar structures manufactured from metal, solid core wire(s), carbon fibers, plastic, elastomer, urethane or other synthetic material. Further, in a preferred embodiment, said load supporting members 350 are placed in predetermined tensile loading between end members 310 and 320 in accordance with anticipated operational parameters.

Load supporting members 350 support the majority of any torsional loading acting on flex shaft assembly 300, but also assist in damping angular motion. When flex shaft assembly 300 is exposed to torque forces or twisting about its longitudinal axis, said load supporting members will constrict or move radially inward toward said central longitudinal axis. Said load supporting members 350 will also tend to pull end members 310 and 320 together (although, typically, not as forcefully as with flex shaft assembly 100). When this occurs, said load supporting members 350 engage against the outer surface of inner core member 340; thus, in a preferred embodiment, inner core member 340 should have sufficient radial and axial strength to resist such loading. When inner core member 340 is a coiled spring, it is to be observed that its winding orientation should be in the opposite direction as helically-oriented load supporting members 350.

Because of the helical pattern of load supporting members 350, and depending on the amount of tensile loading imposed on said load supporting members, it is to be observed that alternative embodiment flex shaft 300 can be configured to permit greater axial bending or deflection compared to flex shaft assembly 100 (having relatively straight load supporting members 50).

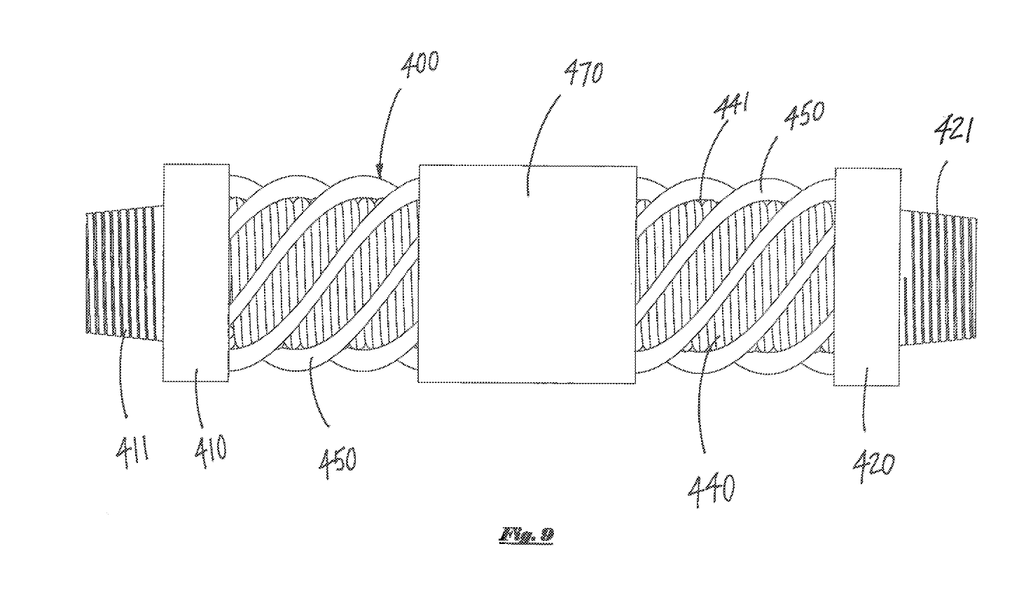

FIG. 9 depicts a side view of a third alternative embodiment flex shaft assembly 400 of the present invention. Alternative flexible shaft assembly 400 of the present invention comprises first end member 410 and second end member 420. First end member 410 is equipped with threaded connection member 411, while second end member 420 is equipped with threaded connection member 421. Inner core member 440 extends between said first end member 410 and second end member 420. Inner core member 440 is substantially cylindrical in shape, and includes a plurality of grooves or recesses 441 that extend circumferentially around the outer surface of said core member 440 in substantially parallel orientation. A plurality of substantially helical load supporting members 450 is disposed in spaced relationship around the outer surface of said core member 440 as more fully described herein.

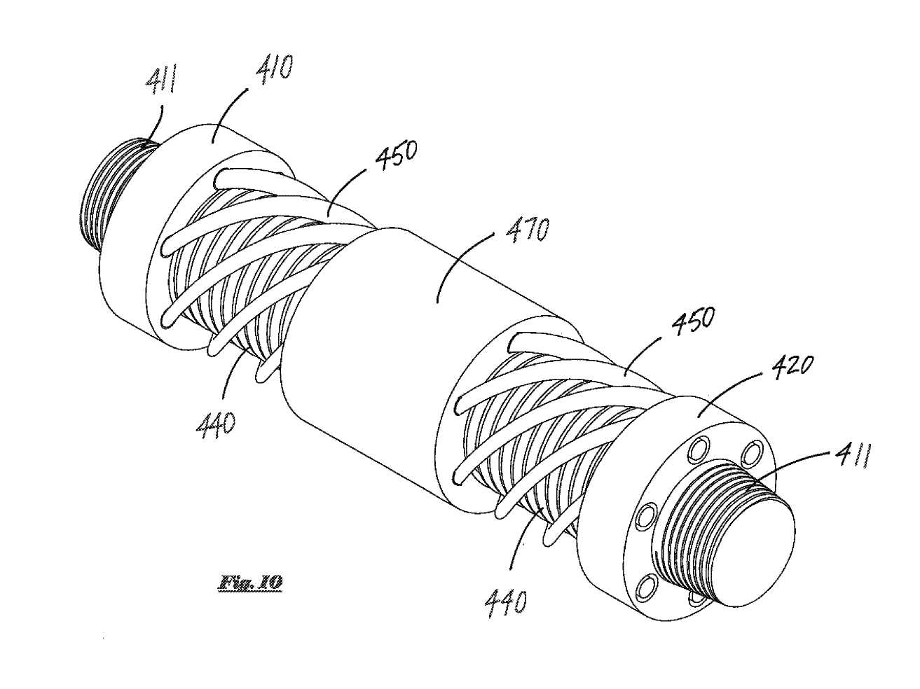

FIG. 10 depicts an end perspective view of said third alternative embodiment flex shaft assembly 400 of the present invention. Although not depicted in FIG. 9 or 10, it is to be observed that an optional casing material (similar to casing material 60 depicted in FIG. 2) can also be optionally disposed over said core member 440 and helical load supporting members 450 between said end members 410 and 420, if desired.

As depicted in FIGS. 9 and 10, third alternative embodiment flex shaft assembly 400 includes substantially rigid center section 470. In a preferred embodiment, said center section 470 comprises a section of substantially solid material that is integrally formed with, or securely attached to, core member 440. A plurality of helical load supporting members 450 extend from first end connection member 410 to center section 470. Similarly, a plurality of helical load supporting members 450 also extend from center section 470 to second end connection member 420

Center section 470 permits flex shaft assembly 400 of the present invention to be selectively extended or shortened as desired by increasing or decreasing the length of center section 470. Moreover, in a preferred embodiment, said center section 470 adds rigidity to the middle portion of flex shaft assembly 400, while only the outer end sections (that is, the region between first end connection member 410 and center section 470, and the region between center section 470 and second end connection member 420, respectively) are capable of axial deflection. Center section 470 allows for a flex shaft assembly 400 having a substantially rigid and inflexible center section, of adjustable length, where bending or axial deflection is desired only at or near the ends of said shaft.

Stress and loading forces can flow undisrupted along the length of the multiple embodiments of the flexible shaft assembly disclosed herein. Unlike conventional alternatives, the flexible shaft assembly of the present invention does not include swivel joint(s) or other discontinuities that can cause weakness and/or wear zones in said shaft. Because said flexible shaft assembly can rigidly link components, while allowing for angular displacement and/or longitudinal deflection without swivels, knuckle joints or other discontinuities, the torque transmitting ability and durability of said shaft assembly increases.

Further, when utilized as a torque transmitting drive shaft, the flex shaft assembly of the present invention can act as an energy storage device to ensure that a work-producing component will not overrun a power generating device. Similarly, said flex shaft of the present invention also act as a torsional shock absorber. Strengths, materials, configurations and/or dimensions of the shaft assembly of the present invention can be altered or adjusted to address various issues such as environmental concerns, corrosion, erosion, loading, speed and/or other requirements for different applications.

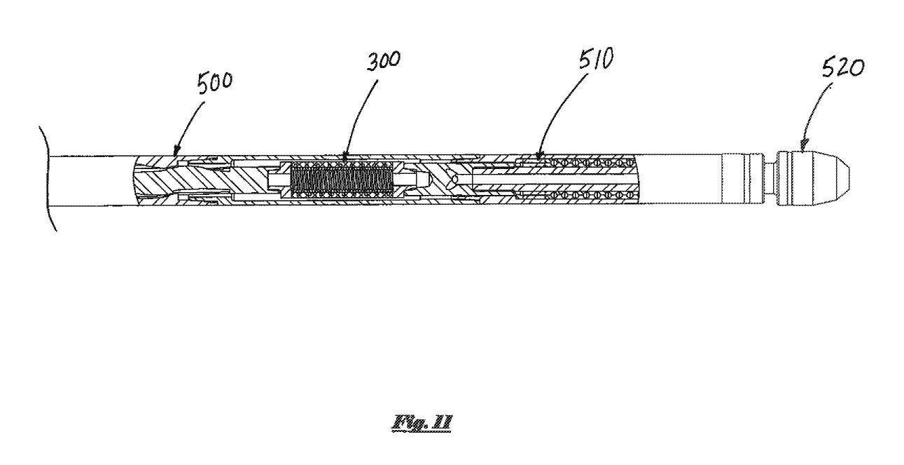

FIG. 11 depicts a side partial sectional view of a flex shaft assembly 300 of the present invention installed as part of a downhole well drilling assembly. As depicted in FIG. 11, flex shaft assembly 300 is installed between mud motor assembly 500 and bearing pack 510 which is, in turn, connected to drill bit 520. Torque forces generated by mud motor assembly 500 are transferred to bearing pack 510 in order to drive rotation of drill bit 520. It is to be observed that flex shaft 300 may be subject to angular displacement or deflection along its longitudinal axis when installed in a directional (that is, not straight) well, or as part of a “bent sub” in a bottom hole assembly.

Because of the ability to modify and customize the design of the flex shaft assembly of the present invention, it is to be observed that said flex shaft assembly can also be used in applications involving relatively severe axial deflection. Such applications include, without limitation, as a speedometer cable or other uses where bending and twisting is required.

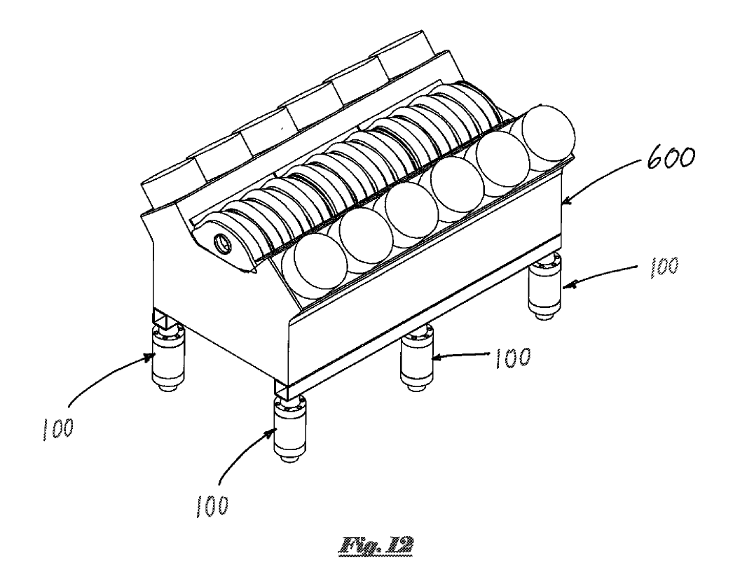

FIG. 12 depicts a side perspective view of a conventional engine block 600 mounted on a plurality of flex shaft assemblies 100 of the present invention. Although flexible shaft assembly 100 of the present invention can be used in an actively powered system as depicted in FIG. 11, said flexible shaft assembly 100 can also be used in a torsionally oscillating system that is passively driven. For example, flexible shaft assembly 100 of the present invention can serve as a linkage between a stationary mounting surface and moving system (such as engine block 600) to dampen motion and vibration; flexible shaft assembly 100 of the present invention limits angular/axial displacement and absorbs torsional forces.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A flexible shaft assembly comprising:
a) a first end connection member;
b) a second end connection member;
c) a core member having a first end, a second end and an outer surface, wherein said first end is attached to said first end connection member, and said second end is connected to said second end connection member;
d) at least one load supporting member having a first end, a second end and an outer surface, wherein said first end is attached to said first end connection member, said second end is connected to said second end connection member, and said at least one load supporting member is disposed along the outer surface of said core member.

2. The flexible shaft assembly of claim 1, further comprising a casing material covering said core member and said at least one load supporting member.

3. The flexible shaft assembly of claim 1, further comprising a central bore extending through said a first end connection member, second end connection member and core member.

4. The flexible shaft assembly of claim 1, wherein said at least one load supporting member comprises a substantially straight elongate member that is oriented substantially parallel to said core member.

5. The flexible shaft assembly of claim 1, wherein said at least one load supporting member has a substantially helical shape and is disposed around said outer surface of said core member.

6. The flexible shaft assembly of claim 1, wherein said inner core is constructed of urethane.
